(19) United States
(12) Patent Application Publication
(10) Pub. No.: US 2026/0005468 A1
(43) Pub. Date: Jan. 1, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuta KANEMATSU, Mie (JP); Sunghyun BYUN, Mie (JP); Nobukazu HIROWAKI, Mie (JP)

(21) Appl. No.: 18/880,846

(22) PCT Filed: Jun. 26, 2023
(86) PCT No.: PCT/JP2023/023456

§ 371 Date: Jan. 3, 2025

(30) Foreign Application Priority Data
Jul. 8, 2022 (JP) 2022-110672

(51) Int. Cl. H01R 13/58; H01R 13/02; H01R 13/426; H01R 13/52

(52) U.S. Cl. CPC H01R 13/582; H01R 13/025; H01R 13/426; H01R 13/5202; H01R 2201/26

(57) ABSTRACT

A connector includes a terminal, a wire, a shield shell including a wire pull-out opening, through which the wire is pulled out, and a back retainer to be fit to the wire pull-out opening. The wire pull-out opening of the shield shell includes a plurality of engaged portions. The back retainer includes a first engaging portion having squeezing ribs provided in a first direction and to be engaged with the engaged portion and a second engaging portion having squeezing ribs provided in a second direction and to be engaged with the engaged portion. The first engaging portion is pressed into contact with the engaged portion via the squeezing ribs in the first direction and the second engaging portion is pressed into contact with the engaged portion via the squeezing ribs in the second direction with the back retainer fit to the wire pull-out opening.

### TECHNICAL FIELD

The present disclosure relates to a connector.

### BACKGROUND

Conventionally, a connector has been used to electrically connect in-vehicle devices. Such a connector includes a connector housing, a terminal accommodated in the connector housing and a wire connected to a terminal, and the wire is pulled out to outside from a wire pull-out opening of the connector housing. Since an external force such as vibration on a vehicle is applied to the wire pulled out to outside, stress may be applied to a contact point of the terminal and a mating terminal and a problem of contact wear and the like may occur if the external force applied to the wire is transmitted to the terminal side. Accordingly, it is necessary in the connector to suppress the transmission of the external force applied to the wire to the terminal side. Thus, a connector disclosed in Patent Document 1 is provided with a back retainer made of resin and to be assembled with a connector housing while holding a wire.

### PRIOR ART DOCUMENT

### Patent Document

Patent Document 1: JP 2011-054393 A

### SUMMARY OF THE INVENTION

### Problems to be Solved

However, in Patent Document 1, the back retainer is assembled by engaging a locking portion in the form of a lock claw provided on the tip of a resilient projecting piece provided in the connector housing with a locked portion provided on the back retainer when the locking portion rides over the locked portion while being resiliently deformed and resiliently returns. Thus, it is unavoidable that a slight gap is formed between the locking portion and the locked portion and an external force transmitted to a wire may be transmitted to a terminal side due to rattling in this gap.

Further, as a current of an in-vehicle device has increased in recent years, a wire has been enlarged in diameter and, to ensure a sufficient holding force for preventing the swing of such a large-size wire, a back retainer made of resin has to be enlarged and a problem that the enlargement of a connector is unavoidable has been inherent. In response to this problem, it is thought to make the back retainer of metal and increase a holding force, but the back retainer having a complicated shape needs to be formed by aluminum die casing or the like, causing an unfavorable increase in manufacturing cost.

Accordingly, a connector is disclosed which can suppress or hinder the transmission of an external force applied to a wire to a terminal side while suppressing the enlargement of the connector itself and an increase in manufacturing cost.

### Means to Solve the Problem

The present disclosure is directed to a connector with a terminal accommodated in a connector housing, a wire connected to the terminal, the wire being pulled out to outside of the connector housing, a shield shell made of metal, the shield shell being fixed to the connector housing to cover the connector housing, the shield shell including a tubular wire pull-out opening, the wire being pulled out through the wire pull-out opening, and a back retainer made of synthetic resin, the back retainer including a wire inserting tube portion for holding the wire press-fit and inserted thereinto, the back retainer being fit to the wire pull-out opening, the wire pull-out opening of the shield shell including a plurality of engaged portions provided apart from each other in a circumferential direction of the wire pull-out opening, the back retainer including a first engaging portion having squeezing ribs provided on both sides in a first direction orthogonal to an extension direction of the wire and to be engaged with the engaged portion and a second engaging portion having squeezing ribs provided on both sides in a second direction orthogonal to both the extension direction of the wire and the first direction and to be engaged with the engaged portion, and the first engaging portion being pressed into contact with the engaged portion via the squeezing ribs on the both sides in the first direction and the second engaging portion being pressed into contact with the engaged portion via the squeezing ribs on the both sides in the second direction with the back retainer fit to the wire pull-out opening.

### Effect of the Invention

According to a connector of the present disclosure, it is possible to suppress or hinder the transmission of an external force applied to a wire to a terminal side while suppressing the enlargement of the connector itself and an increase in manufacturing cost.

### BRIEF DESCRIPTION OF THE DRAWINGS

FIG. 1 is a perspective view showing a connector according to one embodiment.

FIG. 2 is a plan view enlargedly showing an essential part of the connector shown in FIG. 1.

FIG. 3 is a transverse section enlargedly showing a cross-section along III-III in FIG. 2.

FIG. 4 is a transverse section enlargedly showing a cross-section along IV-IV in FIG. 2.

FIG. 5 is a partial exploded perspective view showing the connector shown in FIG. 1 with a back retainer shown in a disassembled state.

FIG. 6 is a transverse section, corresponding to FIG. 3, showing a state where the back retainer is removed in the connector shown in FIG. 1.

FIG. 7 is a perspective view showing an upper retainer constituting the back retainer of the connector shown in FIG. 1 when viewed from above.

FIG. 8 is a perspective view of the upper retainer shown in FIG. 7 when viewed from below.

FIG. 9 is a plan view of the upper retainer shown in FIG. 7.

FIG. 10 is a back view of the upper retainer shown in FIG. 7.

### DETAILED DESCRIPTION TO EXECUTE THE INVENTION

### Description of Embodiments of Present Disclosure

First, embodiments of the present disclosure are listed and described.

(1) The connector of the present disclosure is provided with a terminal accommodated in a connector housing, a wire connected to the terminal, the wire being pulled out to outside of the connector housing, a shield shell made of metal, the shield shell being fixed to the connector housing to cover the connector housing, the shield shell including a tubular wire pull-out opening, the wire being pulled out through the wire pull-out opening, and a back retainer made of synthetic resin, the back retainer including a wire inserting tube portion for holding the wire press-fit and inserted thereinto, the back retainer being fit to the wire pull-out opening, the wire pull-out opening of the shield shell including a plurality of engaged portions provided apart from each other in a circumferential direction of the wire pull-out opening, the back retainer including a first engaging portion having squeezing ribs provided on both sides in a first direction orthogonal to an extension direction of the wire and to be engaged with the engaged portion and a second engaging portion having squeezing ribs provided on both sides in a second direction orthogonal to both the extension direction of the wire and the first direction and to be engaged with the engaged portion, and the first engaging portion being pressed into contact with the engaged portion via the squeezing ribs on the both sides in the first direction and the second engaging portion being pressed into contact with the engaged portion via the squeezing ribs on the both sides in the second direction with the back retainer fit to the wire pull-out opening.

According to the connector of the present disclosure, the wire pulled out from the connector housing is inserted and held in a press-fit state in the wire inserting tube portion of the back retainer made of synthetic resin, and this back retainer is fit to the wire pull-out opening of the shield shell made of metal and fixed to the connector housing. The back retainer includes the first engaging portion to be pressed into contact with the engaged portion of the wire pull-out opening via the squeezing ribs on the both sides (e.g. both upper and lower sides) in the first direction orthogonal to the extension direction of the wire and the second engaging portion to be pressed into contact with the engaged portion of the wire pull-out opening via the squeezing ribs on the both sides (e.g. both left and right sides) in the second direction orthogonal to both the extension direction of the wire and the first direction with the back retainer fit to the wire pull-out opening. Thus, even if the back retainer is fit to the wire pull-out opening of the shield shell while being allowed to slightly rattle, the first and second engaging portions are pressed into contact with the engaged portions while squeezing the squeezing ribs in both the first direction (e.g. vertical direction) and the second direction (e.g. lateral direction), which are two directions orthogonal to the extension direction (axial direction) of the wire. As a result, rattling is absorbed by the squeezing ribs and a displacement of the back retainer fit to the wire pull-out opening with respect to the wire pull-out opening is suppressed. In this way, a displacement of the back retainer with respect to the shield shell due to vibration on a vehicle or the like can be suppressed, utilizing the squeezing ribs while making the back retainer of synthetic resin without enlarging the connector housing and the back retainer or making the back retainer of metal. Therefore, the transmission of an external force applied to the wire to the terminal side can be suppressed or hindered while the enlargement of the connector itself and a manufacturing cost increase are suppressed. Then, external force blocking performance for suppressing the transmission of an external force from the wire by the back retainer can be improved. Particularly, since the wire pull-out opening, to which the back retainer is fit, is configured utilizing the shield shell made of metal, troubles such as the formation of a gap due to a creep phenomenon in a high temperature environment can be advantageously suppressed and a press-contact state of the engaging portions with the engaged portions via the squeezing ribs can be advantageously maintained as compared to the case where the wire pull-out opening is provided in the connector housing made of synthetic resin.

Note that an arbitrary structure can be adopted as a structure for fitting the back retainer to the wire pull-out opening of the shield shell. For example, the back retainer may be provided with a resilient lock piece, and the resilient lock piece may be locked and fit to a lock projection provided on the shield shell.

(2) Preferably, the plurality of engaged portions of the wire pull-out opening include a plurality of first engaged portions arranged on both sides in the second direction and a plurality of second engaged portions arranged on both sides in the first direction, the back retainer includes a plurality of the first engaging portions arranged on both sides in the second direction and a plurality of the second engaging portions arranged on both sides in the first direction, and the first engaging portions are pressed into contact with the first engaged portions via the squeezing ribs on the both sides in the first direction on the both sides in the second direction and the second engaging portions are pressed into contact with the second engaged portions via the squeezing ribs on the both sides in the second direction on the both sides in the first direction with the back retainer fit to the wire pull-out opening. This is because the engaging portions can be pressed into contact with the engaged portions via the squeezing ribs on the both sides in each of the first and second directions and the transmission of an external force applied to the wire to the terminal side can be suppressed or hindered by more stably suppressing a displacement of the back retainer with respect to the shield shell.

(3) Preferably, a radial dimension of an inner peripheral surface of the wire inserting tube portion of the back retainer is larger than a radial dimension of an outer peripheral surface of the wire inserted through inside of the wire inserting tube portion, a plurality of wire pressing protrusions projecting further radially inward than the outer peripheral surface of the wire project apart from each other on the inner peripheral surface of the wire inserting tube portion, and the respective wire pressing protrusions press an insulation coating constituting the outer peripheral surface of the wire radially inward, whereby the wire is inserted and held in a press-fit state in the wire inserting tube portion.

The radial dimension of the inner peripheral surface of the wire inserting tube portion is larger than that of the outer peripheral surface of the wire and a gap is formed between those peripheral surfaces. Further, the plurality of wire pressing protrusions are provided apart from each other. Thus, the radially outward resilient deformation of the insulation coating pressed by the wire pressing protrusions can be absorbed in the gap extending between the respective wire pressing protrusions. Therefore, an assembly force in assembling the wire inserting tube portion with the wire can be reduced and assembly workability can be improved while the position of the wire in the wire inserting tube portion is advantageously fixed by the wire pressing protrusions pressing the insulation coating. Preferably, the plurality of wire pressing protrusions are desirably separated and scattered from each other in both an axial direction and a circumferential direction of the wire inserting tube portion. In this way, the wire can be fixed by being pressed by the wire pressing protrusions in a wider range and the external force blocking performance for suppressing the transmission of an external force from the wire by the back retainer can be further improved.

(4) Preferably, the back retainer includes a resilient lock piece cantilevered toward the wire pull-out opening of the shield shell and the resilient lock piece includes a fitting hole in a projecting end part, the shield shell includes a lock projection projecting on an outer peripheral surface of the wire pull-out opening, and the back retainer is fit to the wire pull-out opening of the shield shell by fitting the lock projection of the shield shell into the fitting hole of the resilient lock piece of the back retainer. Since the back retainer made of synthetic resin may be provided with the resilient lock piece and the shield shell may be formed with the lock projection, the structure of the shield shell can be simplified and manufacturing cost can be suppressed while the resilient lock piece is easily molded.

(5) Preferably, in (4) described above, the wire pull-out opening of the shield shell includes a recess-like lock piece accommodating portion open in the outer peripheral surface of the wire pull-out opening and the lock projection projects on a bottom surface of the lock piece accommodating portion, and the resilient lock piece of the back retainer is accommodated in the lock piece accommodating portion with the back retainer fit to the shield shell.

Since the resilient lock piece of the back retainer is accommodated in the lock piece accommodating portion of the shield shell with the back retainer fit to the shield shell, the projection of the resilient lock piece toward the outer peripheral side of the wire pull-out opening can be suppressed. In this way, accidental detachment of the back retainer from the wire pull-out opening and the like can be advantageously suppressed by suppressing the interference of the resilient lock piece with another member. Further, since the lock projection of the wire pull-out opening is also provided on the bottom surface of the lock piece accommodating portion, interference with another member can be suppressed by suppressing the projection of the lock projection toward the outer peripheral side of the wire pull-out opening. Note that a depth of the lock piece accommodating portion is more preferably adjusted such that the resilient lock piece does not project toward the outer peripheral side from the outer peripheral surface of the wire pull-out opening.

(6) Preferably, in (5) described above, the wire pull-out opening of the shield shell includes a plurality of the engaged portions in the form of cuts penetrating in a plate thickness direction and open in an end surface on a pull-out side of the wire in a tubular end part located on the pull-out side, at least one of the engaged portions is provided to be open in the bottom surface of the lock piece accommodating portion, and the second engaging portion having a protruding shape and to be press-fit into the at least one engaged portion by projecting from the resilient lock piece toward the wire is provided on a base end side of the resilient lock piece of the back retainer.

Since the engaged portions provided on the wire pull-out opening of the shield shell are in the form of cuts penetrating in the plate thickness direction of the tubular end part, the engaged portions can be provided without enlarging the shield shell. Further, one of the engaged portions is provided to be open in the bottom surface of the lock piece accommodating portion, and the second engaging portion to be press-fit thereinto has the protruding shape projecting toward the wire from the resilient lock piece. Thus, the second engaging portion is provided with good space efficiency, utilizing an empty space on the underside of the resilient lock piece well. In this way, the engaged portion and the second engaging portion to be fit thereinto can be provided in a space-saving manner without enlarging the connector.

(7) Preferably, in (6) described above, the back retainer includes a mounting tube portion to be fit into an inner peripheral side of the tubular end part of the wire pull-out opening and the first engaging portion having a protruding shape and provided on an outer peripheral surface of the mounting tube portion, and the first engaging portion is accommodated in the engaged portion without projecting toward an outer peripheral side of the wire pull-out opening with the back retainer fit to the wire pull-out opening.

The first engaging portion can project on the outer peripheral surface of the mounting tube portion of the back retainer to be fit into the inner peripheral side of the tubular end part of the wire pull-out opening, and can be accommodated into the engaged portion penetrating through the tubular end part in the plate thickness direction and press-fit into the engaged portion. Therefore, the engaged portion and the first engaging portion press-fit thereinto can be arranged, utilizing the tubular end part of the wire pull-out opening, and the engaged portion and the first engaging portion to be fit thereinto can be provided in a space-saving manner without enlarging the connector.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

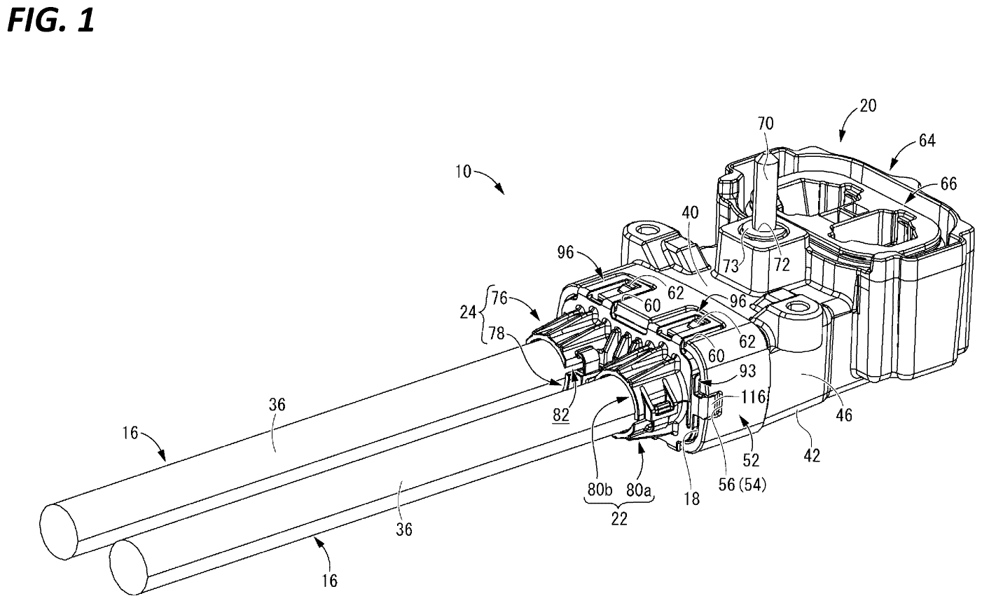

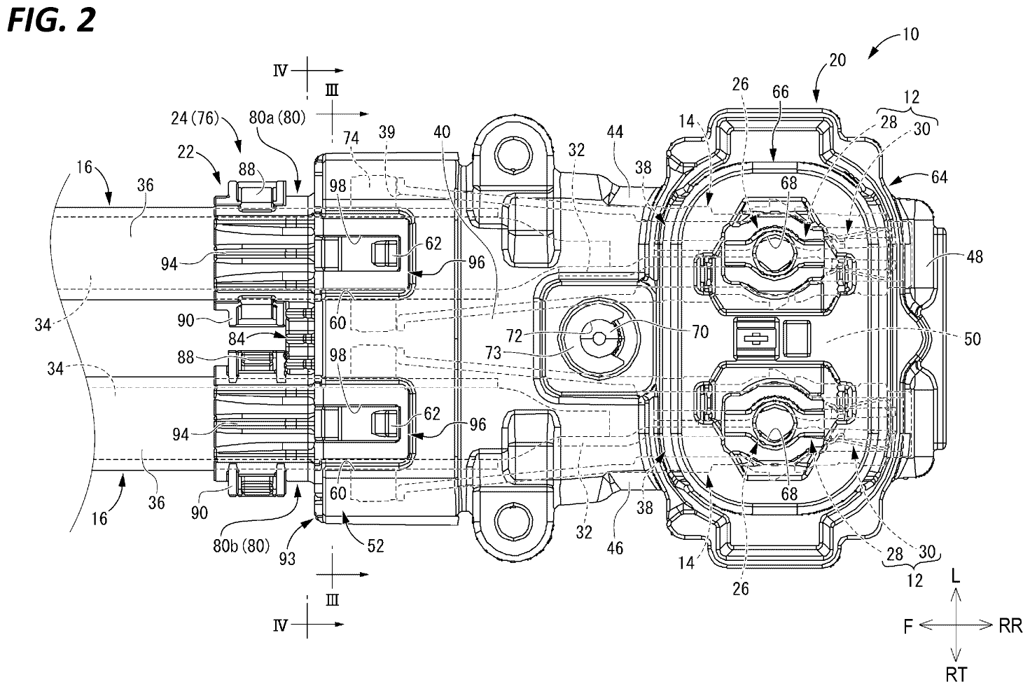

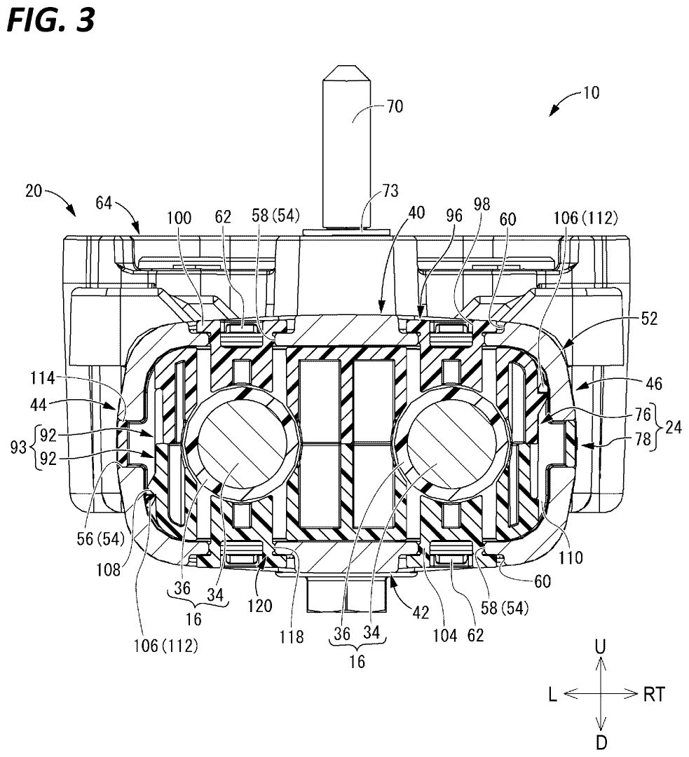

A connector 10 of one embodiment of the present disclosure is described below using FIGS. 1 to 10. The connector 10 includes terminals 12, and the terminals 12 in the connector 10 and mating terminals in an unillustrated mating connector are brought to an electrically conductive state by connecting the connector 10 and the mating connector. Note that the connector 10 can be arranged in an arbitrary orientation. However, in the following description, upper and lower sides in FIG. 3 are referred to as upper and lower sides, left and right sides in FIG. 2 are referred to as front and rear sides, and upper and lower sides in FIG. 2 are referred to as left and right sides. Further, for a plurality of identical members, only some members may be denoted by a reference sign and the other members may not be denoted by the reference sign.

### Connector 10

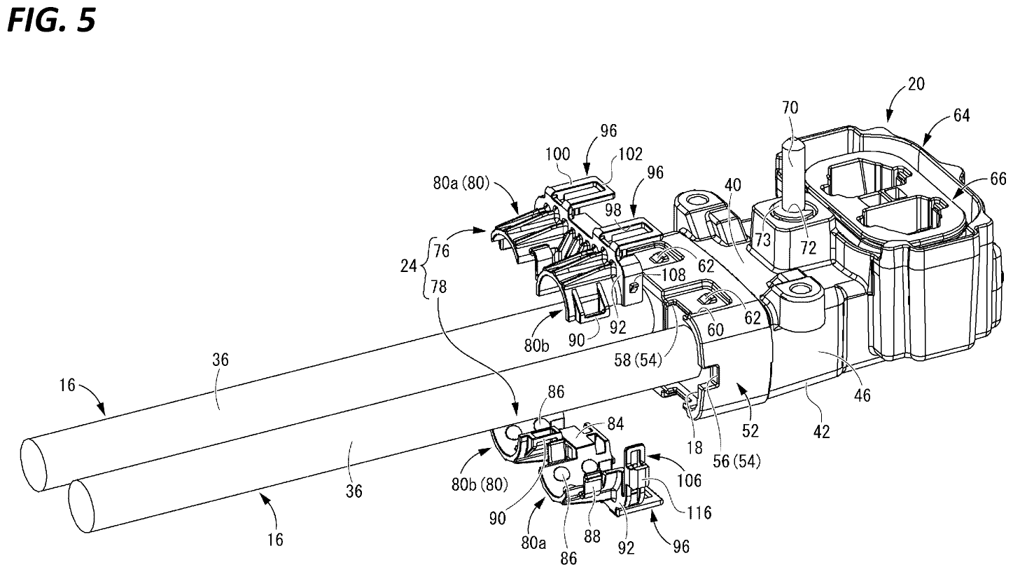

As also shown in FIGS. 1 to 4, the connector 10 includes the terminals 12 accommodated in connector housings 14 and wires 16 to be connected to the terminals 12 and pulled out to the outside of the connector housings 14. Further, the connector 10 includes a shield shell 20 made of metal, to be fixed to the connector housings 14 to cover the connector housings 14 and having a tubular wire pull-out opening 18 (see FIGS. 1 and 5), though which the wires 16 are pulled out, and a back retainer 24 made of synthetic resin, having a wire inserting tube portion 22, in which the wires 16 are inserted and held in a press-fit state, and to be fit to the wire pull-out opening 18. In this embodiment, the connector 10 includes a pair of the terminals 12, 12, a pair of the connector housings 14 for accommodating the respective terminals 12 and a pair of the wires 16 to be connected to the respective terminals 12.

### Terminal 12

In this embodiment, the unillustrated mating terminal to be connected to each terminal 12 is a pin terminal, the specific structure of the terminal 12 is not limited as long as the terminal 12 includes a tubular connecting portion 26, into which the pin-shaped mating terminal is press-fit and, for example, the structure of a female terminal (10) described in Japanese Unexamined Patent Publication No. 2021-028899 can be adopted. More particularly, each terminal 12 of this embodiment includes a terminal body 28 having the tubular connecting portion 26 and a clip spring 30 serving as a resilient member to be attached to a tip part (rear end part) of the terminal body 28. A wire fixing portion 32, to which the wire 16 is fixed, is provided on a base end part (front end part) of each terminal body 28.

Each wire 16 is a coated wire and composed of a core wire 34 and an insulation coating 36 made of synthetic resin and covering the core wire 34 substantially over an entire length. The insulation coating 36 is stripped at an end of the wire 16 to expose the core wire 34 and the exposed core wire 34 is fixed to the wire fixing portion 32 of the terminal body 28, whereby each terminal body 28 and each wire 16 are connected. Note that a method for fixing the wire fixing portion 32 and the core wire 34 is not limited, and the wire fixing portion 32 and the core wire 34 may be fixed by adhesion, welding, crimping using a crimping piece or the like.

### Connector Housing 14

As shown in FIG. 2, the connector housing 14 includes a terminal accommodating portion 38 substantially in the form of a rectangular tube for accommodating a rear end part of the wire 16 and the terminal 12 fixed to the end of the wire 16. As described above, in this embodiment, the pair of connector housings 14, 14 are provided and each connector housing 14 includes the terminal accommodating portion 38. The respective connector housings 14 (respective terminal accommodating portions 38) are separated from each other in a lateral direction and extend in a front-rear direction. The respective wires 16 accommodated in the respective terminal accommodating portions 38 are pulled out to an outside space through front openings 39 of the respective connector housings 14 (respective terminal accommodating portions 38).

Note that a method for fixing each of these connector housings 14 and the shield shell 20 to be fixed to each connector housing 14 while covering each connector housing 14 is not limited, but each connector housing 14 is inserted into the shield shell 20 through a front opening (wire pull-out opening 18) as described later. Each connector housing 14 is fixed to the shield shell 20, for example, by fitting projections and recesses provided on the outer surface of each connector housing 14 and the inner surface of the shield shell 20.

### Shield Shell 20

The shield shell 20 has a substantially tube shape open forward as a whole and substantially entirely covers the pair of connector housings 14, 14. That is, the shield shell 20 is provided with an upper wall portion 40 for covering the respective connector housings 14 from above, a lower wall portion 42 for covering the respective connector housings 14 from below, a left wall portion 44 for covering the left connector housing 14 from left, a right wall portion 46 for covering the right connector housing 14 from right and a rear wall portion 48 for covering the respective connector housings 14 from behind. Further, a partitioning portion 50 partitioning an internal space of the shield shell 20 in the lateral direction is provided between the respective connector housings 14 (respective terminal accommodating portions 38) in the lateral direction inside the shield shell 20.

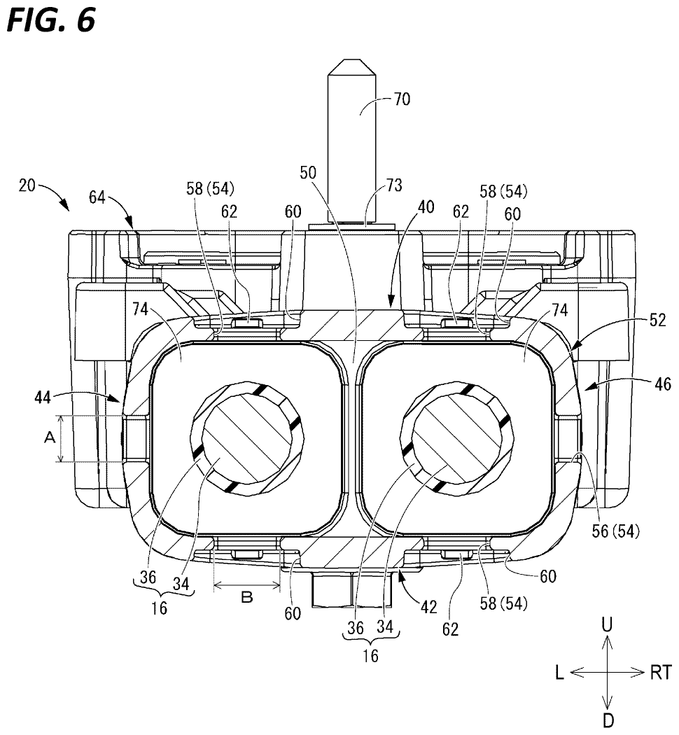

This partitioning portion 50 extends forward from the rear wall portion 48 of the shield shell 20 and is formed with such a dimension in the front-rear direction as not to reach the front opening of the shield shell 20. In this way, the front opening of the shield shell 20 has a substantially rectangular tube shape surrounded on four sides by the upper, lower, left and right wall portions 40, 42, 44 and 46 as also shown in FIGS. 3 and 6. Each wire 16 pulled out forward through the front opening 39 of each connector housing 14 is pulled out to the outside of the shield shell 20 through the front opening of the shield shell 20 having a substantially rectangular tube shape, and the tubular wire pull-out opening 18 is configured by this front opening of the shield shell 20.

Particularly, a tubular end part 52 is configured on a front end part in a pull-out direction of the respective wires 16 in the wire pull-out opening 18 of the shield shell 20. That is, the tubular end part 52 is a substantially tubular part surrounded by the upper, lower, left and right wall portions 40, 42, 44 and 46 as described above, and substantially flat parts are provided in lateral intermediate parts of the upper and lower wall portions 40, 42 and in vertical intermediate parts of the left and right wall portions 44, 46. In the tubular end part 52, the upper and lower wall portions 40, 42 are connected to the left and right wall portions 44, 46 at both lateral end parts and these connected parts are formed into curved parts with rounded corners.

### Engaged Portions 54

Here, a plurality of engaged portions 54 separated from each other in a circumferential direction of the wire pull-out opening 18 are provided in the wire pull-out opening 18 of the shield shell 20. Specifically, in the tubular end part 52 of the wire pull-out opening 18, the plurality of engaged portions 54 in the form of cuts are provided to penetrate in a plate thickness direction and open in an end surface on a pull-out side (front side) of the respective wires 16. More particularly, the plurality of engaged portions 54 are provided on both sides in a first direction (vertical direction in this embodiment) orthogonal to an extension direction (front-rear direction) of the respective wires 16 and both sides in a second direction (lateral direction in this embodiment) orthogonal to both the extension direction of the respective wires 16 and the first direction in the tubular end part 52. That is, the engaged portions 54 include a plurality of first engaged portions 56 arranged on the both sides in the second direction (lateral direction) and a plurality of second engaged portions 58 arranged on the both sides in the first direction (vertical direction) in the tubular end part 52. In short, as also shown in FIGS. 5 and 6, the first engaged portions 56 are respectively provided in the left and right wall portions 44, 46 constituting the tubular end part 52, and the second engaged portions 58 are respectively provided in the upper and lower wall portions 40, 42 constituting the tubular end part 52.

The respective first engaged portions 56 are provided in the substantially flat vertical intermediate parts in the left and right wall portions 44, 46 constituting the tubular end part 52, are open in the front end surface of the tubular end part 52 and penetrates in the lateral direction, which is the plate thickness direction. Each of these first engaged portions 56 has a predetermined vertical dimension A (see FIG. 6).

The respective second engaged portions 58 are provided in the substantially flat lateral intermediate parts in the upper and lower wall portions 40, 42 constituting the tubular end part 52 and, in this embodiment, a pair of the second engaged portions 58, 58 are provided apart from each other in the lateral direction in each of the upper and lower wall portions 40, 42. Each second engaged portion 58 is open in the front end surface of the tubular end part 52, penetrates in the vertical direction, which is the plate thickness direction, and has a predetermined lateral dimension B (see FIG. 6).

### Lock Piece Accommodating Portions 60

Particularly, in this embodiment, recess-like lock piece accommodating portions 60 for accommodating later-described resilient lock pieces 96 in the back retainer 24 are provided to be open on an outer peripheral side and forward in the outer peripheral surface of the wire pull-out opening 18 in the shield shell 20. Specifically, a pair of the lock piece accommodating portions 60, 60 are provided apart from each other in the lateral direction and open vertically outward toward the outer peripheral side and forward in the substantially flat lateral intermediate part of each of the upper and lower wall portions 40, 42 constituting the wire pull-out opening 18 (tubular end part 52). Each second engaged portion 58 described above penetrates in the vertical direction, which is the plate thickness direction, i.e. is provided to be open in the bottom surface of the lock piece accommodating portion 60, in the front end surface of a bottom part of the lock piece accommodating portion 60. Further, lock projections 62 projecting vertically outward are provided on the outer peripheral surface of the wire pull-out opening 18. In this embodiment, the lock projection 62 projecting vertically outward is provided behind the second engaged portion 58 in the bottom surface of each lock piece accommodating portion 60.

Note that an unillustrated through hole penetrating through the upper wall portion 40 in the thickness direction (vertical direction) is formed in a rear part of the upper wall portion 40 of the shield shell 20, and the tubular connecting portion 26 of each terminal 12 arranged inside the shield shell 20 is exposed to the outside space through this through hole. Further, a tubular portion 64 projecting upward is provided on a peripheral edge part of the through hole provided in the upper wall portion 40. The tubular portion 64 has a substantially elliptical shape with a dimension in the lateral direction larger than a dimension in the front-rear direction, and a front retainer 66 is assembled on an inner peripheral side of this tubular portion 64. Substantially circular through holes 68 are formed to penetrate in the vertical direction at positions corresponding to the tubular connecting portions 26 of the respective terminals 12 in the front retainer 66, and the pin-shaped mating terminals are inserted into the tubular connecting portions 26 of the respective terminals 12 through these through holes 68 when the connector 10 and the mating connector are connected. Note that the tubular portion 64 and the front retainer 66 can be fixed to each other, for example, by an unillustrated locking mechanism.

Further, a bolt insertion hole 72, into which a fastening bolt 70 is inserted, is formed to penetrate in the vertical direction in front of the tubular portion 64 in a lateral central part of the shield shell 20. This fastening bolt 70 is, for example, fastened to a casing of a mating device provided with the unillustrated mating terminals, and the mating terminals can be press-fit into the tubular connecting portions 26 of the respective terminals 12, utilizing a fastening force of the fastening bolt 70. Note that the fastening bolt 70 inserted into the bolt insertion hole 72 can be prevented from coming out from the bolt insertion hole 72, for example, by a fixing member 73 such as a C-ring.

An annular waterproof rubber 74 is externally fit and mounted on each wire 16 pulled out forward from the front opening 39 of each connector housing 14 inside the shield shell 20. Each waterproof rubber 74 is inserted into the shield shell 20 through the front opening (wire pull-out opening 18) of the shield shell 20 and located in front of the connector housing 14. Further, the back retainer 24 for preventing the detachment of each waterproof rubber 74 is assembled with the shield shell 20.

### Back Retainer 24

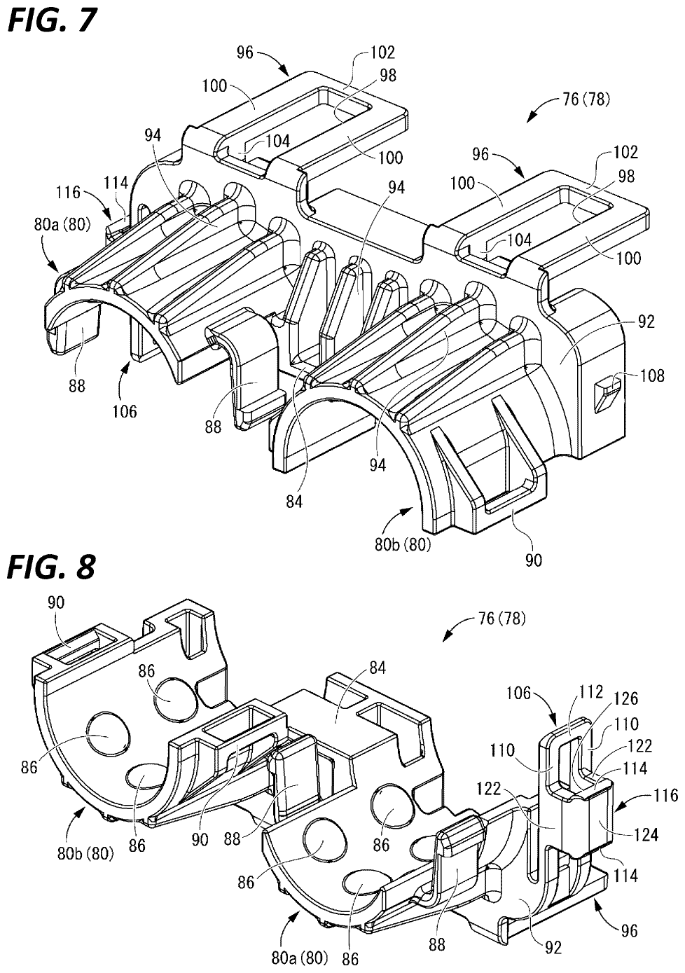

In this embodiment, the back retainer 24 is composed of an upper retainer 76 and a lower retainer 78, which can be assembled with each other in the vertical direction. Particularly, in this embodiment, the upper and lower retainers 76, 78 have the same shape and the back retainer 24 is configured by assembling the upper and lower retainers 76, 78 vertically inverted from each other with each other. Note that, since the upper and lower retainers 76, 78 have the same shape, the upper retainer 76 is described using FIGS. 7 to 10 and the lower retainer 78 is not described below.

As described above, since the back retainer 24 includes the wire inserting tube portions 22 for holding the wires 16 inserted and press-fit therein, these wire inserting tube portions 22 also have a vertically divided structure. That is, the upper retainer 76 includes divided tube portions 80 constituting the wire inserting tube portions 22 by being assembled with another vertically inverted upper retainer 76. Since the pair of wires 16, 16 are provided apart from each other in the lateral direction in this embodiment, the upper retainer 76 is provided with a pair of divided tube portions 80, 80 separated from each other in the lateral direction.

Particularly, in this embodiment, circumferential lengths are different in front parts of the pair of divided tube portions 80, 80 provided on both left and right sides, and the first divided tube portion 80a provided on the left side is formed to have the circumferential length (e.g. about ⅓ of a circumference) shorter than half the circumference, and the second divided tube portion 80b provided on the right side is formed to have the circumferential length of about half the circumference. In this way, as shown in FIG. 1, when each wire inserting tube portion 22 is configured by overlapping each first divided tube portion 80a and each second divided tube portion 80b in the vertical direction, gaps 82 extending in the front-rear direction are formed in the circumferential direction between the first and second divided tube portions 80a, 80b.

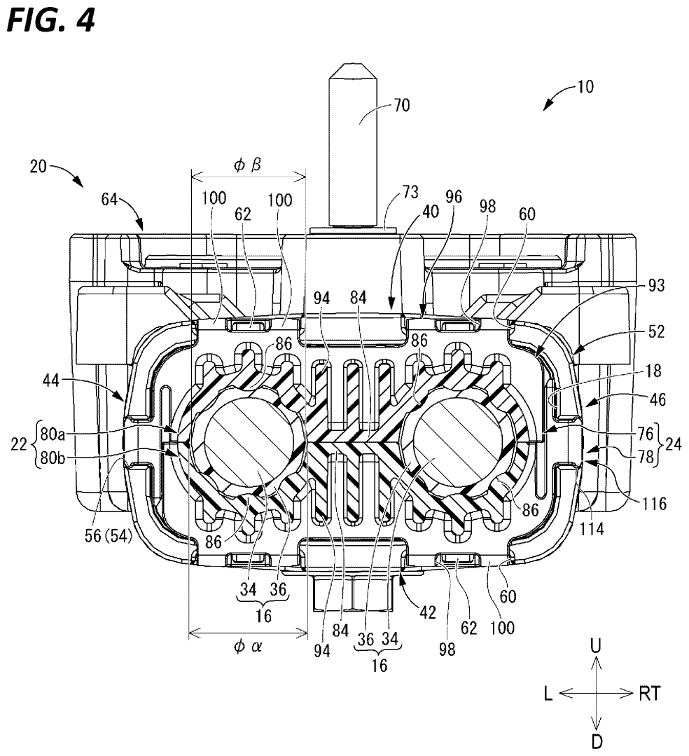

These first and second divided tube portions 80a, 80b are respectively connected by a coupling portion 84 in rear parts thereof. Note that the circumferential lengths of the first and second divided tube portions 80a, 80b are respectively about half the circumference at connected positions by this coupling portion 84. Thus, when each wire inserting tube portion 22 is configured by overlapping each first divided tube portion 80a and each second divided tube portion 80b in the vertical direction as shown in FIG. 4, circumferential end surfaces of the respective rear parts of each first divided tube portion 80a and each second divided tube portion 80b butt against each other to configure the substantially hollow cylindrical wire inserting tube portion 22. Note that, as shown in FIG. 4, a radial dimension ϕα (see FIG. 4) of the inner peripheral surface of each wire inserting tube portion 22 constituted by each first divided tube portion 80a and each second divided tube portion 80b is larger than a radial dimension ϕβ (see FIG. 4) of the outer peripheral surface of each wire 16 inserted through the inside of each wire inserting tube portion 22.

### Wire Pressing Protrusions 86

As also shown in FIGS. 4 and 8, a plurality of wire pressing protrusions 86 projecting radially inward are formed on the inner peripheral surfaces of the first and second divided tube portions 80a, 80b. A plurality of the wire pressing protrusions 86 are arranged apart from each other in the circumferential direction on the same circumferences in each of the first and second divided tube portions 80a, 80b. Further, the plurality of the wire pressing protrusions 86 arranged apart from each other in the circumferential direction on the same circumferences are arranged apart from each other at two positions in the front-rear direction. The plurality of wire pressing protrusions 86 provided in the first divided tube portion 80a and the plurality of wire pressing protrusions 86 provided in the second divided tube portion 80b are substantially at the same positions in the front-rear direction. Therefore, when each wire inserting tube portion 22 is configured by overlapping each first divided tube portion 80a and each second divided tube portion 80b in the vertical direction, the plurality of wire pressing protrusions 86 are arranged apart from each other in the circumferential direction substantially over the entire circumferences in each wire inserting tube portion 22 having a substantially hollow cylindrical shape.

As shown in FIG. 4, the plurality of wire pressing protrusions 86 project further radially inward than the outer peripheral surface of each wire 16 inserted in each wire inserting tube portion 22. As a result, the insulation coating 36 constituting the outer peripheral surface of each wire 16 is pressed radially inward by the respective wire pressing protrusions 86. In this way, each wire 16 is inserted and held in a press-fit state in each wire inserting tube portion 22. Note that, since the back retainer 24 is moved rearward and assembled with the shield shell 20 after the back retainer 24 is mounted on the respective wires 16 as described later in this embodiment, a displacement of the back retainer 24 in the front-rear direction with respect to the respective wires 16 is possible while the insulation coatings 36 of the respective wires 16 are pressed by the respective wire pressing protrusions 86.

Further, lock claw portions 88 projecting downward are provided on the outer peripheral surface of the front part of the first divided tube portion 80a, and lock frame bodies 90 projecting toward an outer peripheral side are provided on the outer peripheral surface of the front part of the second divided tube portion 80b. In this embodiment, a pair of lock claw portions 88, 88 are provided on both left and right sides in the first divided tube portion 80a, and a pair of lock frame bodies 90, 90 are provided on both left and right sides in the second divided tube portion 80b. In this way, when each wire inserting tube portion 22 is configured by overlapping each first divided tube portion 80a and each second divided tube portion 80b in the vertical direction, the respective lock claw portions 88 and/or the respective lock frame bodies 90 are resiliently deformed and engaged. As a result, the separation of each first divided tube portion 80a and each second divided tube portion 80b is hindered and each wire inserting tube portion 22 is maintained to have the substantially hollow cylindrical shape.

A base portion 92 is provided in rear end parts of the first divided tube portion 80a, the second divided tube portion 80b and the coupling portion 84 described above. In other words, the first divided tube portion 80a, the second divided tube portion 80b and the coupling portion 84 project forward from the base portion 92. As also shown in FIG. 10, the base portion 92 has a substantially rectangular shape as a whole when viewed from the front-rear direction, but is recessed into a substantially semicircular shape in parts corresponding to the first divided tube portion 80a and the second divided tube portion 80b and has a predetermined thickness (dimension in the front-rear direction).

When the back retainer 24 is configured by assembling the upper retainer 76 and the vertically inverted other upper retainer 76 in the vertical direction, the base portion 92 and a vertically inverted other base portion 92 are overlapped in the vertical direction. As shown in FIGS. 1 and 3, by overlapping a pair of these base portions 92, 92 in the vertical direction, a mounting tube portion 93 to be fit into an inner peripheral side of the tubular end part 52 of the wire pull-out opening 18 is configured. That is, with the back retainer 24 assembled with the shield shell 20 to configure the connector 10, the mounting tube portion 93 is fit in the tubular end part 52 and located in front of each waterproof rubber 74.

A plurality of ribs 94 extending forward from the base portion 92 are provided on the upper surfaces of the first divided tube portion 80a, the second divided tube portion 80b and the coupling portion 84, and are separated from each other in the lateral direction. Each of the plurality of these ribs 94 is formed to have a substantially triangular or trapezoidal shape when viewed from the lateral direction, and has a part with a vertical dimension gradually reduced from rear to front. Each of the first divided tube portion 80a, the second divided tube portion 80b and the coupling portion 84 is reinforced by the plurality of these ribs 94.

Particularly, since each rib 94 has a larger vertical dimension in a rear part than in a front part, a reinforcing effect in a part near the wire pull-out opening 18 is relatively strongly exhibited and a displacement of each wire 16 inserted through each wire inserting tube portion 22 near the wire pull-out opening 18 is prevented when the back retainer 24 is fit to the wire pull-out opening 18 of the shield shell 20. In contrast, since the vertical dimension of the front part of each rib 94 is smaller than that of the rear part, the first and second divided tube portions 80a, 80b are allowed to be resiliently deformed to a certain extent and a possibility of damaging each wire 16 is reduced when each wire 16 is largely displaced with respect to the first and second divided tube portions 80a, 80b.

### Resilient Lock Pieces 96

The resilient lock pieces 96 cantilevered rearward, i.e. toward the wire pull-out opening 18 of the shield shell 20, are provided on an upper end part of the base portion 92. The upper retainer 76 is provided with a pair of the resilient lock pieces 96, 96, and the respective resilient lock pieces 96 are separated from each other in the lateral direction. Specifically, the respective resilient lock pieces 96 are provided at positions corresponding to the first and second divided tube portions 80a, 80b. Further, a substantially rectangular fitting hole 98 penetrating in the vertical direction is provided in a projecting end part (rear end part) of each of these resilient lock pieces 96.

More particularly, each resilient lock piece 96 includes a pair of rearward projecting portions 100, 100 separated from each other in the lateral direction and projecting rearward from the upper end part of the base portion 92 and a connecting portion 102 connecting projecting tip parts (rear end parts) of these rearward projecting portions 100. The fitting hole 98 is configured by a region surrounded by these rearward projecting portions 100 and connecting portion 102. Further, as also shown in FIGS. 7 and 10, a downward extending portion 104 extending downward along the rear surface of the base portion 92 is provided on a projecting base end part (front end part) of each rearward projecting portion 100. As shown in FIGS. 4 and 10, squeezing ribs 118 of a second engaging portion 120 to be described later are provided on the laterally outer surfaces of the respective downward extending portions 104 separated from each other in the lateral direction.

On the laterally outer surfaces of the base portion 92, a resilient lock frame body 106 projecting downward is provided on the left end surface and a lock claw portion 108 projecting rightward is provided on the right end surface. The resilient lock frame body 106 is resiliently deformable in the lateral direction. By causing the upper retainer 76 and the vertically inverted other upper retainer 76 to face each other in the vertical direction and engaging the resilient lock frame bodies 106 and the lock claw portions 108, the back retainer 24 is configured. That is, the separation of the pair of upper retainers 76, 76 is hindered and the back retainer 24 is configured by engaging the resilient lock frame bodies 106 and the lock claw portions 108 in addition to the engagement of the lock claw portions 88 and the lock frame bodies 90.

Note that the resilient lock frame body 106 includes a pair of downward projecting portions 110, 110 separated from each other in the front-rear direction and projecting downward from the base portion 92 and a connecting portion 112 connecting projecting tip parts (lower end parts) of these downward projecting portions 110. The lock claw portion 108 is engaged in a region surrounded by these downward projecting portions 110 and connecting portion 102.

### First Engaging Portions 116 and Second Engaging Portions 120

Here, the back retainer 24 is provided with first engaging portions 116 each including squeezing ribs 114, 114 provided on both sides in the first direction (vertical direction) and to be engaged with the first engaged portion 56 constituting the engaged portion 54 and the second engaging portions 120 each including the squeezing ribs 118, 118 provided on both sides in the second direction (lateral direction) and to be engaged with the second engaged portion 58 constituting the engaged portion 54. As described above, in the wire pull-out opening 18, the plurality of first engaged portions 56 are arranged on the both sides in the second direction (lateral direction) and the plurality of second engaged portions 58 are arranged on the both sides in the first direction (vertical direction). Thus, in the back retainer 24, a plurality of the first engaging portions 116 are arranged on the both sides in the second direction and a plurality of the second engaging portions 120 are arranged on the both sides in the first direction.

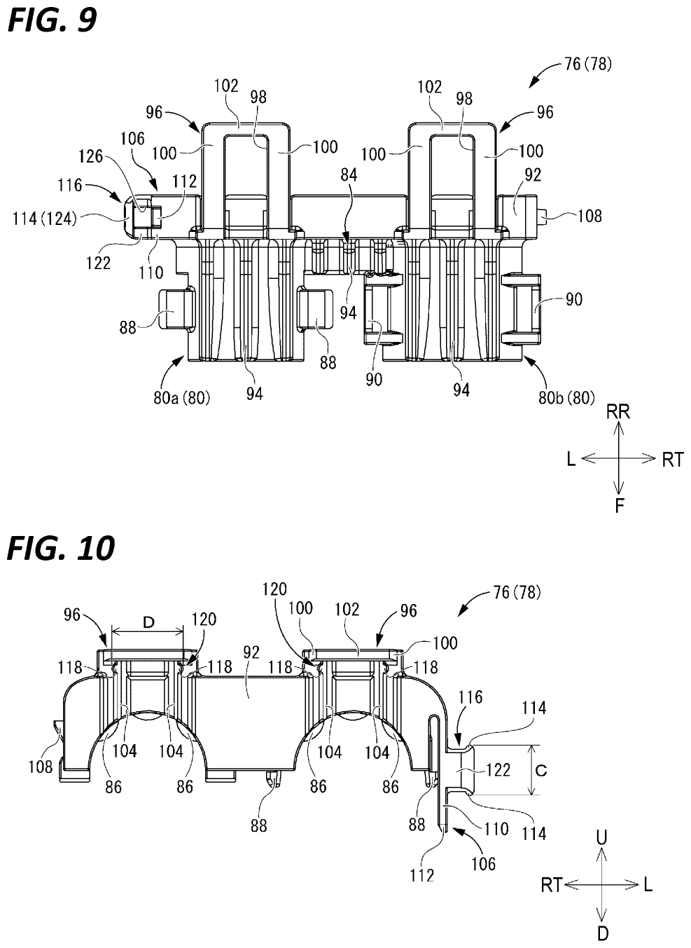

Specifically, in the upper retainer 76, the first engaging portion 116 is formed to project toward an outer peripheral side (leftward) from the outer peripheral surface of the resilient lock frame body 106 provided in a left end part. That is, vertical wall portions 122, 122 projecting leftward and extending in the vertical direction are provided in vertical intermediate parts of the pair of downward projecting portions 110, 110 separated from each other in the front-rear direction in the resilient lock frame body 106. Further, the projecting tips (left ends) of the respective vertical wall portions 122 are coupled by a coupling wall portion 124. As also shown in FIGS. 8 and 9, a substantially rectangular through hole 126 penetrating in the vertical direction is formed in a region surrounded by the respective vertical wall portions 122 and the coupling wall portion 126. The first engaging portion 116 is configured to include the respective vertical wall portions 122 and the coupling wall portion 124, and the squeezing ribs 114, 114 projecting further toward the both sides in the first direction (vertical direction) than the respective vertical wall portions 122 are provided on both upper and lower end surfaces of the coupling wall portion 124. By assembling the pair of upper retainers 76, 76 thus shaped with each other in the vertical direction, the first engaging portions 116 are provided on both sides in the second direction (lateral direction) of the back retainer 24. Further, since projecting from the outer peripheral surfaces of the resilient lock frame bodies 106 constituting the base portions 92, the first engaging portions 116 project also from the outer peripheral surface of the mounting tube portion 93 constituted by the pair of base portions 92, 92.

In a single state of the upper retainer 76 before the first engaging portion 116 is engaged with the first engaged portion 56, a vertical dimension C (see FIG. 10) between the projecting tips of the respective squeezing ribs 114 is larger than the vertical dimension A of the first engaged portion 56 described above. In this way, when the back retainer 24 is fit to the wire pull-out opening 18 and each first engaging portion 116 is fit into each first engaged portion 56, each first engaging portion 116 is pressed into contact with each first engaged portion 56 via the respective squeezing ribs 114 on the both sides in the first direction (vertical direction). Further, when each first engaging portion 116 is fit into each first engaged portion 56, each first engaging portion 116 is accommodated in each first engaged portion 56 without projecting toward the outer peripheral side of the wire pull-out opening 18.

Further, as described above, the squeezing ribs 118, 118 of the second engaging portion 120 are provided on the laterally outer surfaces of the respective downward extending portions 104 extending downward from the pair of rearward projecting portions 100, 100 separated in the lateral direction in each resilient lock piece 96 in the upper retainer 76. Specifically, the respective squeezing ribs 118 are provided on upper end parts of the respective downward extending portions 104, and each second engaging portion 120 is configured to include the upper end parts of the respective downward extending portions 104. That is, on a base end side (front side) of each resilient lock piece 96 of the back retainer 24 (upper retainer 76), each second engaging portion 120 having a protruding shape is configured to include the respective downward extending portions 104 projecting toward each wire 16 (downward) from each resilient lock piece 96. By assembling the pair of upper retainers 76, 76 thus shaped with each other in the vertical direction, the second engaging portions 120 are provided on both sides in the first direction (vertical direction) of the back retainer 24.

In a single state of the upper retainer 76 before the second engaging portions 120 are engaged with the second engaged portions 58, a lateral dimension D (see FIG. 10) between the projecting tips of the respective squeezing ribs 118 is larger than the lateral dimension B of the second engaged portion 58 described above. In this way, when the back retainer 24 is fit to the wire pull-out opening 18 and each second engaging portion 120 is fit into each second engaged portion 58, each second engaging portion 120 is pressed into contact with each second engaged portion 58 via the respective squeezing ribs 118 on the both sides in the second direction (lateral direction). Note that, as shown in FIG. 3, a space may be provided between the respective downward extending portions 104 in the lateral direction, and the respective downward extending portions 104 may be able to be slightly resiliently deformed inward in facing directions when the respective squeezing ribs 118 are pressed into contact with each second engaged portion 58.

By forming the upper retainer 76 into such a shape, a mold can be removed in the vertical direction during the molding of the upper retainer 76. In this way, the types of molds are not increased and a cost increase is avoided. Further, an increase in the number of types of components is suppressed and cost is reduced also by forming the upper and lower retainers 76, 78 into the same shape. Note that the upper and lower retainers need not necessarily have the same shape.

### Assembly of Connector 10

An example of a specific method for assembling the connector 10 is described below. Note that the assembly method of the connector 10 is not limited to the one described below.

First, the core wire 34 exposed by stripping the insulation coating 36 in the end of each wire 16 is fixed to the wire fixing portion 32 of each terminal body 28, and the clip spring 30 is attached to the rear end part of each terminal body 28. In this way, the terminal 12 is connected to the end of each wire 16. Then, the waterproof rubber 74 is externally fit and mounted on each wire 16.

Subsequently, each wire 16 having the terminal 12 and the waterproof rubber 74 assembled therewith is inserted through the front opening 39 of each connector housing 14. After each terminal 12 is inserted to a predetermined position, each connector housing 14 having the terminal 12 assembled therewith is inserted through the front opening (wire pull-out opening 18) of the shield shell 20 and fixed to the shield shell 20, for example, by concave-convex fitting. Further, the front retainer 66 is mounted into the tubular portion 64 of the shield shell 20 from above. In this way, as shown in FIG. 5, each wire 16 is pulled out to outside (forward) from the wire pull-out opening 18 in the shield shell 20. Note that the fastening bolt 70 is inserted into the bolt insertion hole 72 at a suitable timing.

Subsequently, as shown in FIG. 5, the upper retainer 76 and the lower retainer 78, i.e. the upper retainer 76 and the vertically inverted other upper retainer 76, are caused to face each other in the vertical direction to vertically sandwich the respective wires 16 in parts of the respective wires 16 pulled out forward from the wire pull-out opening 18 of the shield shell 20. Thereafter, the pair of upper retainers 76, 76 are brought closer in the vertical direction, and the respective lock claw portions 88 and the respective lock frame bodies 90, and the respective resilient lock frame bodies 106 and the respective lock claw portions 108 are engaged. In this way, the back retainer 24 is mounted at a position separated forward from the shield shell 20 on the respective wires 16.

Subsequently, the back retainer 24 mounted on the respective wires 16 is moved rearward toward the shield shell 20. In this way, the respective resilient lock pieces 96 projecting rearward in the back retainer 24 are inserted into the respective lock piece accommodating portions 60 open forward in the wire pull-out opening 18 of the shield shell 20 and accommodated into the respective lock piece accommodating portions 60. Then, the respective resilient lock pieces 96 ride over the respective lock projections 62 provided on the bottom surfaces of the respective lock piece accommodating portions 60 while being resiliently deformed, whereby the respective lock projections 62 are fit into and engaged with the respective fitting holes 98 of the respective resilient lock pieces 96.

Further, the respective first engaging portions 116 and the respective second engaging portions 120 are inserted into the respective first engaged portions 56 and the respective second engaged portions 58, which are both open forward in the wire pull-out opening 18 of the shield shell 20. In this way, the respective squeezing ribs 114 on the respective first engaging portions 116 and the respective squeezing ribs 118 on the respective second engaging portions 120 are compressed and deformed to be squeezed by the respective first engaged portions 56 and the respective second engaged portions 58, whereby the respective first engaging portions 116 and the respective second engaging portions 120 are pressed into contact with the respective first engaged portions 56 and the respective second engaged portions 58. As a result, the back retainer 24 is fit to the wire pull-out opening 18 of the shield shell 20 and the connector 10 is completed.

According to the connector 10 of this embodiment structured as described above, the first engaging portions 116 including the respective squeezing ribs 114 and the second engaging portions 120 including the respective squeezing ribs 118 in the back retainer 24 are fit into the plurality of engaged portions 54 (first engaged portions 56 and second engaged portions 58) in the wire pull-out opening 18 of the shield shell 20. Particularly, by deforming the respective squeezing ribs 114, 118 to be squeezed into the respective first engaged portions 56 and the respective second engaged portions 58, the respective first engaging portions 116 and the respective second engaging portions 120 are pressed into contact with the respective first engaged portions 56 and the respective second engaged portions 58. Thus, the rattling of the shield shell 20 and the back retainer 24 is prevented. In this way, even if an external force such as vibration input from outside is exerted to each wire 16 and, for example, each wire 16 swings in the vertical direction or the lateral direction, the back retainer 24 is displaced with respect to the shield shell 20 to prevent the external force from being exerted to the terminal 12 connected to each wire 16.

Particularly, the respective first engaging portions 116 and the respective first engaged portions 56 are provided on the both sides in the second direction (lateral direction), and the respective second engaging portions 120 and the respective second engaged portions 58 are provided on the both sides in the first direction (vertical direction). In this way, the respective first engaging portions 116 and the respective first engaged portions 56, and the respective second engaging portions 120 and the respective second engaged portions 58 can be symmetrically arranged in the lateral direction and the vertical direction in the circumferential direction of the wire pull-out opening 18, and a displacement of the back retainer 24 with respect to the shield shell 20 can be further suppressed.

The respective wire pressing protrusions 86 on the back retainer 24 press the insulation coating 36 of each wire 16 radially inward, whereby each wire 16 is inserted and held in a press-fit state in each wire inserting tube portion 22. In this way, a displacement amount of each wire 16 with respect to the back retainer 24 can be suppressed to be small. Particularly, in this embodiment, the plurality of wire pressing protrusions 86 separated and arranged in the circumferential direction in each wire inserting tube portion 22 are separated and arranged also in an axial direction, and a displacement amount can be effectively suppressed for a displacement in a rotation direction (twist) of each wire 16.

The back retainer 24 includes the respective resilient lock pieces 96 and the shield shell 20 includes the respective lock projections 62, and the back retainer 24 is fit to the wire pull-out opening 18 of the shield shell 20 by fitting the respective lock projections 62 to the respective resilient lock pieces 96. In this way, the assembly of the back retainer 24 with the shield shell 20 can be realized by a simple structure including the respective resilient lock pieces 96 and the respective lock projections 62. Particularly, since the respective lock piece accommodating portions 60 for accommodating the respective resilient lock pieces 96 are provided to be open in the outer peripheral surface in the shield shell 20, a projecting amount of each resilient lock piece 96 from each lock piece accommodating portion 60 can be made small or eliminated. In this way, the back retainer 24 and the shield shell 20 and, consequently, the connector 10 can be reduced in size. Further, it is also possible to reduce a possibility that the back retainer 24 is detached from the shield shell 20 due to accidental disengagement of the respective resilient lock pieces 96 and the respective lock projections 62.

Particularly, the second engaged portion 58 is provided in the bottom part of each lock piece accommodating portion 60 for accommodating the resilient lock piece 96, and the second engaging portion 120 to be press-fit into the second engaged portion 58 is provided on the base end side (front side) of each resilient lock piece 96. That is, the respective lock piece accommodating portions 60 and the respective second engaged portions 58 are continuously provided in the vertical direction in the upper and lower wall portions 40, 42 in the shield shell 20, and the enlargement of the shield shell 20 can be avoided, for example, as compared to the case where the respective lock piece accommodating portions and the respective second engaged portions are provided at position different in the circumferential direction of the wire pull-out opening. Similarly, the respective resilient lock pieces 96 and the respective second engaging portions 120 can be provided at the same positions in the circumferential direction of the mounting tube portion 93 in the back retainer 24, and the enlargement of the back retainer 24 can also be avoided.

With the back retainer 24 fit to the shield shell 20, the respective first engaging portions 116 are accommodated in the respective first engaged portions 56 without projecting toward the outer peripheral side of the wire pull-out opening 18. In this way, each first engaging portion 116 can be prevented from being accidentally disengaged from the first engaged portion 56 due to the contact of another member, a worker or the like.

### Modifications

Although the embodiment has been described in detail as a specific example of the present disclosure above, the present disclosure is not limited by this specific description. Modifications, improvements and the like within a range in which the aim of the present disclosure can be achieved are included in the present disclosure. For example, the following modifications of the embodiment are also included in the technical scope of the present disclosure.
(1) The shape of the terminal 12 in the above embodiment is merely illustrative, but not restrictive. That is, although the terminal 12 includes the tubular connecting portion 26, into which the pin-shaped mating terminal is inserted, in the above embodiment, there is no limitation to this mode. A mating terminal may be in the form of a flat tab as described, for example, in International Publication No. WO 2021/145197 and, in that case, a terminal may include a substantially rectangular terminal insertion gap.
(2) Although the plurality of first engaged portions 56 and the plurality of second engaged portions 58 are provided and the plurality of first engaging portions 116 and the plurality of second engaging portions 120 are provided to correspond to the plurality of first engaged portions 56 and the plurality of second engaged portions 58 in the above embodiment, there is no limitation to this mode. That is, in the connector according to the present disclosure, it is sufficient to provide a plurality of engaged portions and first and second engaging portions to be engaged with these engaged portions. For example, two engaged portions and one first engaging portion and one second engaging portion may be provided. Even in such a mode, ratting in the first direction is suppressed by squeezing ribs provided on both sides in the first direction (vertical direction in the above embodiment) in the first engaging portion, and ratting in the second direction is suppressed by squeezing ribs provided on both sides in the second direction (lateral direction in the above embodiment) in the second engaging portion. Therefore, displacements of a back retainer with respect to a shield shell in two directions orthogonal to each other can be suppressed. Note that the numbers of the first engaging portions and the second engaging portions are not limited and at least one or more first engaging portions and at least one or more second engaging portions may be provided.
(3) Although the respective lock piece accommodating portions 60 are provided in the outer peripheral surface of the wire pull-out opening 18 in the shield shell 20 and the respective lock projections 62 are provided on the bottom surfaces of the respective lock piece accommodating portions 60 in the above embodiment, there is no limitation to this mode. That is, in the connector according to the present disclosure, the lock piece accommodating portions may not be provided. For example, lock projections may project toward an outer peripheral side from the outer peripheral surface of a wire pull-out opening in a shield shell and, in that case, each resilient lock piece is arranged to overlap the outer peripheral surface of the wire pull-out opening in the shield shell.
(4) Although each second engaging portion 120 is provided on the base end side (front side) of each resilient lock piece 96 in the above embodiment, a first engaging portion may be provided on a base end side of a resilient lock piece instead of or in addition to the second engaging portion. That is, although the respective resilient lock pieces 96 are provided on the both sides in the vertical direction of the back retainer 24 in the above embodiment, resilient lock piece(s) may be provided on one side or both sides in the lateral direction of a back retainer and engaged with lock projection(s) provided on one side or both sides in the lateral direction of a shield shell. Note that, the resilient lock pieces are not essential in the connector according to the present disclosure.
(5) Although the back retainer 24 is composed of the upper retainer 76 and the lower retainer 78 (the pair of upper retainers 76, 76) having the same shape in the above embodiment, an upper retainer and a lower retainer may have different shapes. Note that the upper and lower retainers may be integrally formed. For example, a hinge portion may be provided on one circumferential end part of the upper and lower retainers to make the upper and lower retainers openable and closable, and the upper and lower retainers may be fixed to each other by a locking mechanism or the like provided on the other circumferential end part of the upper and lower retainers after wire(s) is/are sandwiched.

### LIST OF REFERENCE NUMERALS

10 connector
12 terminal
14 connector housing
16 wire
18 wire pull-out opening
20 shield shell
22 wire inserting tube portion
24 back retainer
26 tubular connecting portion
28 terminal body
30 clip spring
32 wire fixing portion
34 core wire
36 insulation coating
38 terminal accommodating portion
39 front opening
40 upper wall portion
42 lower wall portion
44 left wall portion
46 right wall portion
48 rear wall portion
50 partitioning portion
52 tubular end part
54 engaged portion
56 first engaged portion
58 second engaged portion
60 lock piece accommodating portion
62 lock projection
64 tubular portion
66 front retainer
68 through hole
70 fastening bolt
72 bolt insertion hole
73 fixing member
74 waterproof rubber
76 upper retainer
78 lower retainer
80 divided tube portion
80a first divided tube portion
80b second divided tube portion
82 gap
84 coupling portion
86 wire pressing protrusion
88 lock claw portion
90 lock frame body
92 base portion
93 mounting tube portion
94 rib
96 resilient lock piece
98 fitting hole
100 rearward projecting portion
102 connecting portion
104 downward extending portion
106 resilient lock frame body
108 lock claw portion
110 downward projecting portion
112 connecting portion
114 squeezing rib
116 first engaging portion
118 squeezing rib
120 second engaging portion
122 vertical wall portion
124 coupling wall portion
126 through hole

1. A connector, comprising:
a terminal accommodated in a connector housing;
a wire connected to the terminal, the wire being pulled out to outside of the connector housing;
a shield shell made of metal, the shield shell being fixed to the connector housing to cover the connector housing, the shield shell including a tubular wire pull-out opening, the wire being pulled out through the wire pull-out opening; and
a back retainer made of synthetic resin, the back retainer including a wire inserting tube portion for holding the wire press-fit and inserted thereinto, the back retainer being fit to the wire pull-out opening,
the wire pull-out opening of the shield shell including a plurality of engaged portions provided apart from each other in a circumferential direction of the wire pull-out opening,
the back retainer including a first engaging portion having squeezing ribs provided on both sides in a first direction orthogonal to an extension direction of the wire and to be engaged with the engaged portion and a second engaging portion having squeezing ribs provided on both sides in a second direction orthogonal to both the extension direction of the wire and the first direction and to be engaged with the engaged portion, and
the first engaging portion being pressed into contact with the engaged portion via the squeezing ribs on the both sides in the first direction and the second engaging portion being pressed into contact with the engaged portion via the squeezing ribs on the both sides in the second direction with the back retainer fit to the wire pull-out opening.

2. The connector of claim 1, wherein:
the plurality of engaged portions of the wire pull-out opening include a plurality of first engaged portions arranged on both sides in the second direction and a plurality of second engaged portions arranged on both sides in the first direction,
the back retainer includes a plurality of the first engaging portions arranged on both sides in the second direction and a plurality of the second engaging portions arranged on both sides in the first direction, and
the first engaging portions are pressed into contact with the first engaged portions via the squeezing ribs on the both sides in the first direction on the both sides in the second direction and the second engaging portions are pressed into contact with the second engaged portions via the squeezing ribs on the both sides in the second direction on the both sides in the first direction with the back retainer fit to the wire pull-out opening.

3. The connector of claim 1, wherein:
a radial dimension of an inner peripheral surface of the wire inserting tube portion of the back retainer is larger than a radial dimension of an outer peripheral surface of the wire inserted through inside of the wire inserting tube portion,
a plurality of wire pressing protrusions projecting further radially inward than the outer peripheral surface of the wire project apart from each other on the inner peripheral surface of the wire inserting tube portion, and
the respective wire pressing protrusions press an insulation coating constituting the outer peripheral surface of the wire radially inward, whereby the wire is inserted and held in a press-fit state in the wire inserting tube portion.

4. The connector of claim 1, wherein:
the back retainer includes a resilient lock piece cantilevered toward the wire pull-out opening of the shield shell and the resilient lock piece includes a fitting hole in a projecting end part,
the shield shell includes a lock projection projecting on an outer peripheral surface of the wire pull-out opening, and
the back retainer is fit to the wire pull-out opening of the shield shell by fitting the lock projection of the shield shell into the fitting hole of the resilient lock piece of the back retainer.

5. The connector of claim 4, wherein:
the wire pull-out opening of the shield shell includes a recess-like lock piece accommodating portion open in the outer peripheral surface of the wire pull-out opening and the lock projection projects on a bottom surface of the lock piece accommodating portion, and
the resilient lock piece of the back retainer is accommodated in the lock piece accommodating portion with the back retainer fit to the shield shell.

6. The connector of claim 5, wherein:
the wire pull-out opening of the shield shell includes a plurality of the engaged portions in the form of cuts penetrating in a plate thickness direction and open in an end surface on a pull-out side of the wire in a tubular end part located on the pull-out side,
at least one of the engaged portions is provided to be open in the bottom surface of the lock piece accommodating portion, and
the second engaging portion having a protruding shape and to be press-fit into the at least one engaged portion by projecting from the resilient lock piece toward the wire is provided on a base end side of the resilient lock piece of the back retainer.

7. The connector of claim 6, wherein:
the back retainer includes a mounting tube portion to be fit into an inner peripheral side of the tubular end part of the wire pull-out opening and the first engaging portion having a protruding shape and provided on an outer peripheral surface of the mounting tube portion, and
the first engaging portion is accommodated in the engaged portion without projecting toward an outer peripheral side of the wire pull-out opening with the back retainer fit to the wire pull-out opening.
